(19) United States
(12) Patent Application Publication
(10) Pub. No.: US 2025/0327519 A1
(43) Pub. Date: Oct. 23, 2025

(54) SHAFT SEAL APPARATUS AND METHOD OF FABRICATION

(71) Applicant: Hernon Manufacturing, Inc., Sanford, FL (US)

(72) Inventors: Harry Arnon, Longwood, FL (US); Josef Arnon, Longwood, FL (US); Thomas John Bray, New Smyrna, FL (US)

(73) Assignee: Hernon Manufacturing, Inc., Sanford, FL (US)

(21) Appl. No.: 19/175,476

(22) Filed: Apr. 10, 2025

Related U.S. Application Data
(60) Provisional application No. 63/633,334, filed on Apr. 12, 2024.

(51) Int. Cl. F16J 15/3284; F16J 15/328

(52) U.S. Cl. CPC F16J 15/3284; F16J 15/328

(57) ABSTRACT

A shaft seal assembly for sealing a rotatable shaft. The shaft seal assembly includes a shaft seal having an outer diameter portion forming an annular base and an inner diameter portion including an annular shaft contacting surface. A shaft housing includes a plate having a central opening defined by a circumferential sidewall parallel to the longitudinal direction of a shaft extending therethrough and narrowed by a perpendicular endwall at one end. The annular base of the shaft seal has an outer surface configured to be pressed against the circumferential sidewall and proximate the endwall. A sealing layer is printed and cured on the outer surface forming a sealing engagement to the circumferential sidewall.

### CROSS REFERENCE TO RELATED APPLICATIONS

This application claims the benefit of U.S. Provisional Patent Application No. 63/633,334, filed 12 Apr. 2024.

### FILED OF THE INVENTION

This invention relates to sealing devices and more specifically to shaft seals.

### BACKGROUND OF THE INVENTION

Many mechanical devices use rotating shafts in some capacity. Devices with rotating shafts use oil or lubricant for various reasons, such as to reduce friction from the rotating shaft and other components used in the machine to rotate the shaft and/or to wick away heat from the mechanism. When oil or lubricant is used, an interior of the device containing the oil or lubricant must be sealed to prevent the egress of the oil or lubricant. While static edges of a housing or casing can be tightly compressed against a gasket to prevent leakage, it is more problematic to seal an opening through which a rotating shaft extends. Shaft seals are used to create a leakproof mating surface around a rotating shaft that prevents oil, lubricant or other liquids from leaking. Shaft seals, also known as oil seals and lip seals, are devices that prevent fluids from leaking out of machinery from around a rotating shaft. Seals are necessary when a shaft extends from a housing containing oil, such as a pump, a gear box, and the like. They are typically made from a stamped metal, rubber and/or plastic material and are designed to fit around the shaft to create a barrier that keeps oil, grease or other fluids contained.

Shaft seals work like most other seals by compressing against the surface, or in this case the shaft, on which they are installed. A common type of shaft seal consists of an elastomer ring attached to a metallic base that is press fit into or otherwise attached to an opening in a seal housing through which the shaft extends. The seal housing has a surface against which the metallic base is pressed. The elastomer ring engages the shaft. The sealing is accomplished by a lip on the elastomer ring that is pressed snugly around the shaft. When properly designed and installed, the lip rides on a film of lubricant about 0.0001 inch (0.0025 millimeter) thick. If the film gets too thick, fluid leaks; if it is too thin, the lip gets hot, and the seal may fail. Leather, synthetic rubber, and silicones are among the materials used for the sealing ring.

While shaft seals assemblies are often successfully used, there can be a leakage problem at the junction between the static shaft seal and the seal housing mating surfaces. The engaged surface of the seal housing is generally metal and can have irregularities in the surface. While this surface may appear smooth, there are typically microscopic irregularities such as pores and bumps that can prevent a complete engagement between the shaft seal and the seal housing. Leak paths between these static mating surfaces can be the consequence of minute defects on either mating surface and or surface defects created during the assembly installation process itself. While the leak may not be large, liquid, oil and or lubrication often leaks, or weeps unacceptably between the static mating surfaces. Even small seepage can cause problems. For this reason, manufacturers of shaft seals have traditionally coated the static shaft seal mating surface with a flexible polymer. The traditional coating is assembled utilizing an atomized form of solvent based polymer to the outer diameter of the shaft seal. The established process of “spray painting” coating provides a flexible barrier effectively inhibiting most leaks tribulations. Traditional atomized solvent based coating assembly processes have inherent complications and intrinsic quality control problems. Notable process challenges with atomized solvent based coatings include the presence and hazards of VOCs, air filtration, containment of atomized particulates, targeting coating location, pattern shape, transfer, overspray, thickness, uniformity and dry time.

It would be highly advantageous, therefore, to remedy the foregoing and other deficiencies inherent in the prior art.

Another object of the present invention is the elimination of traditional spray coating VOC solvents, overspray, filtration requirements, and long dry time.

Yet another object of the present invention is to incorporate low maintenance, non-contact methods for inline continuous processing, high speed coating assembly of shapes/patterns, accurate, uniform, consistent, coating thickness from 5 microns/0.0002″ to 25 microns/0.001″ plus, and rapid cure.

### SUMMARY OF THE INVENTION

Briefly to achieve the desired objects and advantages of the instant invention in accordance with a preferred embodiment provided is a shaft seal assembly for sealing a rotatable shaft. The shaft seal assembly includes a shaft seal having an outer diameter portion forming an annular base and an inner diameter portion including an annular shaft contacting surface. A shaft housing includes a plate having a central opening for receiving a rotatable shaft therethrough. The central opening in the plate is defined by a circumferential sidewall parallel to the longitudinal direction of the shaft and narrowed by a perpendicular endwall at one end. The annular base of the shaft seal has an outer surface configured to be pressed against the circumferential sidewall and proximate the endwall. A sealing layer is printed and cured on the outer surface forming a sealing engagement to the circumferential sidewall.

Also provided is a method of sealing a rotatable shaft including the steps of providing a shaft seal to be coated. The shaft seal has an outer diameter portion forming an annular base with an outer surface and an inner diameter portion including an annular shaft contacting surface for contacting a rotatable shaft. The shaft seal is positioned adjacent an inkjet printhead. The seal coating is applying with the inkjet printhead to the outer surface of the annular base. The applied seal coating is then cured. Positioning the shaft seal includes mounting the shaft seal on a fixture carried by a rotatable spindle indexing the outer surface of the annular base to the inkjet printhead. The rotatable spindle is rotated, rotating the shaft seal to print the seal coating around the entire outer surface of the annular base. A printer driver associated with and controlling the inkjet printhead is programmed to print a specific design matching a coverage and thickness desired on the provided shaft seal.

### BRIEF DESCRIPTION OF THE DRAWINGS

Specific objects and advantages of the invention will become readily apparent to those skilled in the art from the following detailed description of a preferred embodiment thereof, taken in conjunction with the drawings in which:

FIG. 1 is a perspective view of a shaft seal assembly, according to the present invention, with a cross-section removed therefrom;

FIG. 2 is an enlarged cross-sectional portion of the shaft seal assembly of FIG. 1, as indicated by detail A;

FIG. 3 is a perspective view of a shaft seal according to the present invention, with a cross-section removed therefrom;

FIG. 4 is an enlarged cross-sectional portion of the shaft seal of FIG. 3, as indicated by detail B;

FIG. 5 is an end view of a seal coating application assembly;

FIG. 6 is a side view of the seal coating application assembly of FIG. 5; and

FIG. 7 is a flow chart of a method of applying a coating to a base of the shaft seal.

### DETAILED DESCRIPTION

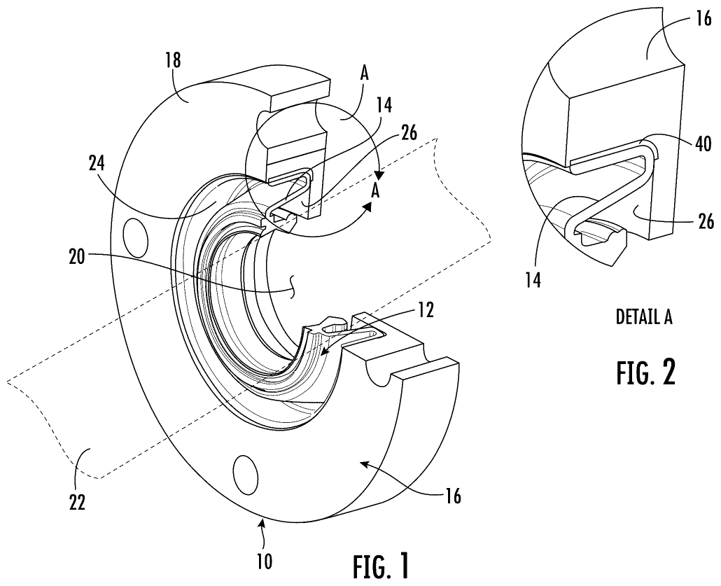

Turning now to the drawings in which like reference characters indicate corresponding elements throughout the several views, attention is directed to FIGS. 1 and 2 which illustrates a shaft seal assembly, generally designated 10. Shaft seal assembly 10 includes a shaft seal 12 having a ring shape and a shaft housing 16. Shaft seal 12 has a annular base 14 and is removably received by shaft housing 16. Shaft housing 16, in this embodiment is a plate 18 having a central opening 20 through which a rotatable shaft 22 extends. Opening 20 is defined by a circumferential sidewall 24 parallel to the longitudinal direction of shaft 22 and narrowed by a perpendicular endwall 26 at one end. Opening 20 is slightly larger than the diameter of shaft 22 at endwall 26 and widens to an increased diameter at circumferential sidewall 24. Thus, an annular cavity is formed in shaft housing 16 encircling shaft 22 and terminating at endwall 26. One of ordinary skill in the art will understand that shaft housing 16 can be plate 18 acting as a cover to close a housing for the shaft mechanism as illustrated, or a portion of the housing itself as an integral element.

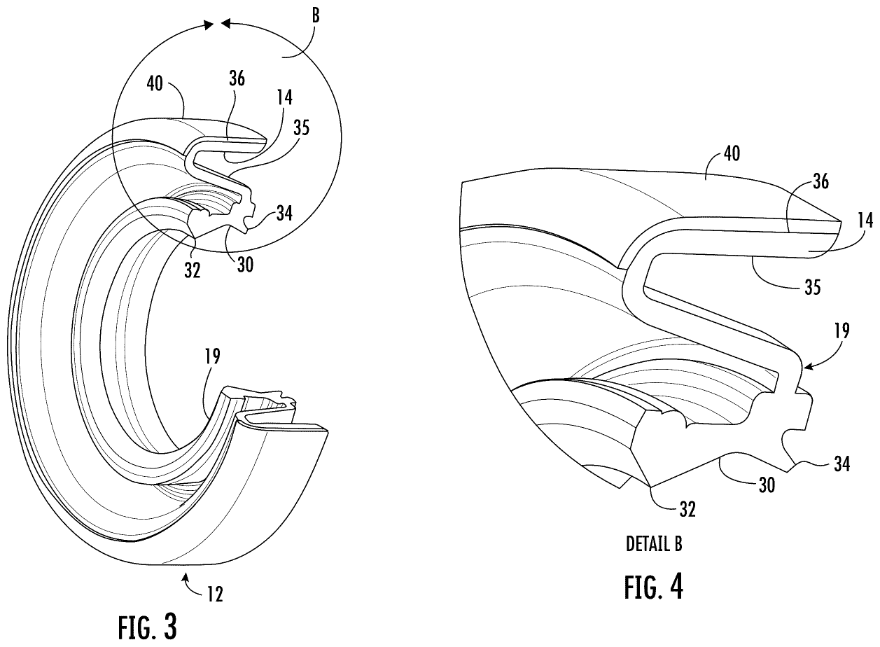

With additional reference to FIGS. 3 and 4, an inner diameter portion 19 of shaft seal 12 includes an annular surface 30, typically having a V-shaped projection 32 extending radially inwardly for contact against and around the surface of a shaft 22. This is a conventional structure and can include a dust lip 34 as well. Other configurations can also be used but will not be discussed herein as they are conventional and well known. A biasing member, such as a spring (not shown), may be employed to bias V-shaped projection 32 against the surface of shaft 22. An outer diameter 35 of shaft seal 12, extending radially outwardly from the inner diameter, forms annular base 14. Annular base 14 includes an outer surface 36 configured to be pressed radially outwardly against circumferential sidewall 24 with shaft seal 12 abutting endwall 26. In this embodiment, annular base 14 takes the form of a compression spring to firmly press outer surface 36 against circumferential sidewall 24 holding shaft seal 12 in position. It will be understood that annular base 14 can be constructed in other configurations to be press fit. In any instance, a light cured coating layer 40 is printed onto outer surface 36 to provide an annular sealing layer to overcome any irregularities in circumferential sidewall 24. The annular sealing layer ensures a non-leaking engagement occurs between outer surface 36 and circumferential sidewall 24 around the entire circumference.

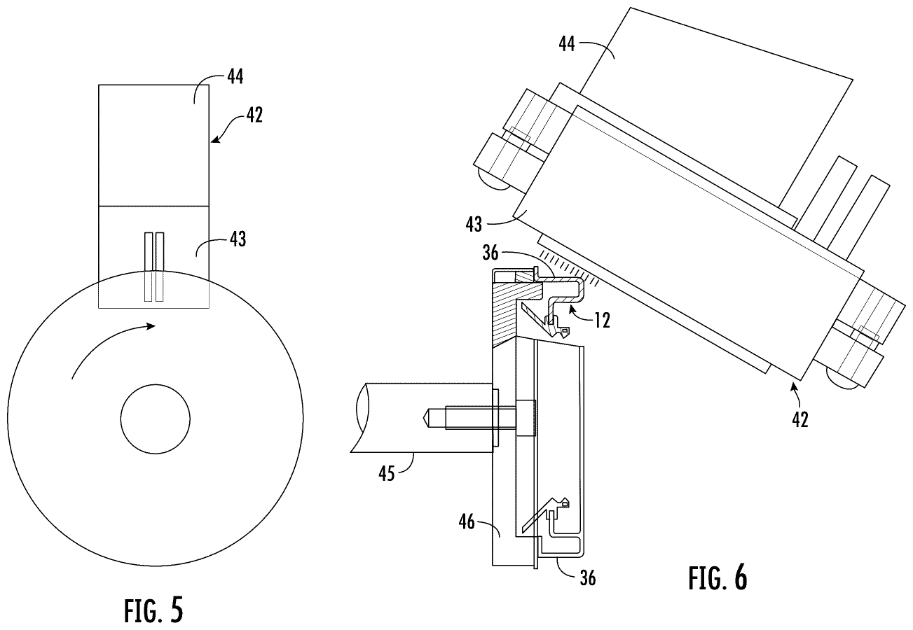

Referring now to FIGS. 5 and 6, light cured coating layer 40 is applied to outer surface 36 of shaft seal 12 using a printing module 42 which includes an inkjet printhead 43 and a printer driver 44. The printer driver 44 can be programmed to operate the inkjet printhead 43 in any pattern desired to cover outer surface 36 having different thickness, shapes and sizes. Shaft seal 12 is positioned and retained relative inkjet printhead 43 by a spindle 45 rotatably supporting a fixture 46 to allow precision printing on shaft seal 12. Shaft seal 12 is secured to fixture 46, such as by using magnets, clips or the like. Spindle 45 is used to rotate fixture 46 and thus control the rotation of shaft seal 12 relative printhead 43 to permit printing of the seal coating entirely around outer surface 36. Inkjet printhead 43 can be a thermal printhead, or as preferred, a piezoelectric printhead. The coating material is provided in liquid form and printed onto the desired areas. Coating layer 40 is preferably a Photocurable Acrylate Resin which may include colorants. This is a radiation-curable formulation consisting primarily of acrylate-functionalized oligomers and monomers that cure under UV or visible light exposure. After shaft seal 12 passes through printing module 42, it is presented to a curing light source 48 to be cured. Curing light source 48 can be fitted to printhead 43 and used after printing, without requiring shaft seal 12 from being removed from fixture 46. While in this preferred embodiment curing light source 48 is carried by printer module 42, a separate unit can be employed if desired. Also, while UV light and UV curable coatings are preferred, it will be understood that other seal coating materials that cure, polymerize and or bond with other methods can be employed.

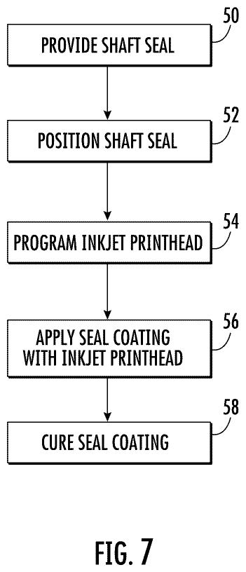

Referring now to FIG. 7, a method of applying a seal coating to shaft seal 12 is illustrated. Step 50 is to provide shaft seal 12 to be coated. Step 52 includes positioning shaft seal 12 adjacent inkjet printhead 43 with specific positioning indexed to inkjet printhead 43. This is accomplished by using spindle 45 and fixture 46. Step 54 includes programming printer driver 44 to control inkjet printhead 43 to print a specific design matching the coverage and thickness desired on the provided shaft seal 12. Step 56 is applying the seal coating to shaft seal 12 with the indexed and programmed inkjet printhead. Step 58 is curing the applied seal coating. The coated shaft seal can then be installed in the shaft housing.

The present invention is described above with reference to illustrative embodiments. Those skilled in the art will recognize that changes and modifications may be made in the described embodiments without departing from the nature and scope of the present invention. Various changes and modifications to the embodiments herein chosen for purposes of illustration will readily occur to those skilled in the art. To the extent that such modifications and variations do not depart from the spirit of the invention, they are intended to be included within the scope thereof.

1. A shaft seal assembly for sealing a rotatable shaft, comprising:
a shaft seal having an outer diameter portion forming an annular base and an inner diameter portion including an annular shaft contacting surface;
a shaft housing including a plate having a central opening for receiving a rotatable shaft therethrough;
the central opening in the plate defined by a circumferential sidewall parallel to the longitudinal direction of the shaft and narrowed by a perpendicular endwall at one end;
the annular base of the shaft seal having an outer surface configured to be pressed against the circumferential sidewall and proximate the endwall; and
a sealing layer printed and cured on the outer surface forming a sealing engagement to the circumferential sidewall.

2. A shaft seal assembly as claimed in claim 1 wherein the base is a biasing member to firmly press the outer surface radially outwardly against the circumferential sidewall holding the shaft seal in position.

3. A shaft seal assembly as claimed in claim 1 wherein the biasing member is a compression spring.

4. A shaft seal assembly as claimed in claim 1 wherein the sealing layer is a cured Photocurable Acrylate Resin.

5. A shaft seal assembly as claimed in claim 1 wherein the sealing layer is printed on the outer surface using an ink jet printer.

6. A shaft seal assembly sealing a rotatable shaft comprising:
a shaft housing including a plate having a central opening with a rotatable shaft extending therethrough;
a shaft seal having an outer diameter portion forming an annular base and an inner diameter portion including an annular shaft contacting surface contacting the rotatable shaft;
the central opening in the plate defined by a circumferential sidewall parallel to the longitudinal direction of the shaft and narrowed by a perpendicular endwall at one end;
the annular base of the shaft seal having an outer surface positioned against the circumferential sidewall and proximate the endwall; and
a sealing layer printed and cured on the outer surface, the sealing layer captured between the outer surface and the circumferential sidewall, forming a sealing engagement between the outer surface and the circumferential sidewall.

7. A shaft seal assembly as claimed in claim 6 wherein the annular base includes a biasing member firmly pressing the outer surface radially outwardly against the circumferential sidewall, holding the shaft seal assembly in position.

8. A shaft seal assembly as claimed in claim 6 wherein the biasing member is a compression spring.

9. A shaft seal assembly as claimed in claim 6 wherein the sealing layer is a cured Photocurable Acrylate Resin.

10. A shaft seal assembly as claimed in claim 6 wherein the sealing layer is printed on the outer surface using an ink jet printer.

11. A method of sealing a rotatable shaft comprising the steps of:
providing a shaft seal to be coated, the shaft seal having an outer diameter portion forming an annular base having an outer surface and an inner diameter portion including an annular shaft contacting surface for contacting a rotatable shaft;
positioning the shaft seal adjacent an inkjet printhead;
applying the seal coating with the inkjet printhead to the outer surface of the annular base; and
curing the applied seal coating.

12. A method as claimed in claim 11 further comprising the step of installing the shaft seal on a shaft housing.

13. A method as claimed in claim 12 wherein the step of installing includes providing the shaft housing including a plate having a central opening with the rotatable shaft extending therethrough, the central opening in the plate defined by a circumferential sidewall parallel to the longitudinal direction of the shaft and narrowed by a perpendicular endwall at one end, the annular base of the shaft seal having the outer surface positioned against the circumferential sidewall and proximate the endwall.

14. A method as claimed in claim 11 wherein the step of positioning the shaft seal includes mounting the shaft seal on a fixture carried by a rotatable spindle indexing the outer surface of the annular base to the inkjet printhead.

15. A method as claimed in claim 13 wherein the step of positioning further includes rotating the rotatable spindle to print the seal coating around the entire outer surface of the annular base.

16. A method as claimed in claim 11 wherein the step of applying further including the step programming a printer driver associated with and controlling the inkjet printhead to print a specific design matching a coverage and thickness desired on the provided shaft seal.

17. A method as claimed in claim 11 wherein the step of applying the seal coating includes providing a seal coating being a Photocurable Acrylate Resin.

18. A method as claimed in claim 17 wherein the Photocurable Acrylate Resin includes acrylate-functionalized oligomers and monomers.
